(19) United States
(12) Patent Application Publication
(10) Pub. No.: US 2012/0009499 A1
(43) Pub. Date: Jan. 12, 2012

(54) COMPRESSION ARRANGEMENT FOR FUEL OR ELECTROLYSIS CELLS IN A FUEL CELL STACK OR AN ELECTROLYSIS CELL STACK

(76) Inventors: Lars Kiilstofte Hansen, Odense C (DK); Jeppe Rass-Hansen, Copenhagen V (DK); Jens Ulrik Nielsen, Soborg (DK); Claus Rasmussen, Slagelse (DK); Ib Skyum, Glostrup (DK)

(21) Appl. No.: 13/256,675

(22) PCT Filed: Dec. 17, 2009
(86) PCT No.: PCT/EP2009/009072

§ 371 Date: Sep. 15, 2011

(30) Foreign Application Priority Data
Mar. 26, 2009 (DK) PA 2009 00418

(51) Int. Cl. H01M 8/24; C25B 9/18

(52) U.S. Cl. 429/456; 204/270

(57) ABSTRACT

A fuel cell stack or an electrolysis cell stack comprises a plurality of cells, which need to be compressed to ensure and maintain internal contact. To achieve an evenly distributed compression force throughout the electrochemically active area a frame with a central aperture is positioned on top of the cell stack between a resilient plate and a top plate. The enclosed aperture forms a compression chamber which is provided with pressurised gas from the cathode inlet, whereby an evenly distributed force is applied to the electrochemically area of the cell stack by the resilient plate.

The invention relates to compression of fuel cell stacks or electrolysis cell stacks, more specifically to a gas compression arrangement for fuel cell stacks or electrolysis cell stacks in particular for Solid Oxide Fuel Cell (SOFC) or Solid Oxide Electrolysis Cell (SOEC) stacks.

In the following the invention will be explained in relation to SOFC stacks. The compression arrangement according to the invention can, however, also be used for other types of fuel cells such as Polymer Electrolyte Fuel cells (PEM) or a Direct Methanol Fuel Cell (DMFC). Further the invention can also be used for electrolysis cells such as Solid Oxide Electrolysis Cell stacks.

The electro-chemical reactions and the function of a fuel cell or electrolysis cell is not the essence of the present invention, thus this will not be explained in detail but considered known for a person skilled in the art, and for the sake of simplicity, the following explanation to the invention will mention SOFCs only, even though the invention can also be used for SOECs and other types of fuel cells as mentioned.

A SOFC stack of the planar type is built up of a plurality of flat plate solid oxide fuel cells. To increase the voltage produced by the SOFC, the plurality of cell units are stacked on top of each other to form a stack and are linked together by interconnects. The stack is inserted between two planar end plates. The solid oxide fuel cells are sealed at their edges by gas seals of typically glass or other brittle materials in order to prevent leakage of gas from the sides of the stack. Hence, each fuel cell is divided in a seal area, which is sought to be minimized and an electrochemically active area which should be as large a part of the fuel cell area as possible since the efficiency of the cell is dependant on the size of this active area relative to the total cell area.

The interconnects serve as a gas barrier to separate the anode (fuel) and cathode (air/oxygen) sides of adjacent cell units, and at the same time they enable current conduction between the adjacent cells, i.e. between an anode of one cell with a surplus of electrons and a cathode of a neighbouring cell needing electrons for the reduction process. The current conduction between the interconnect and its neighbouring electrodes is enabled via a plurality of contact points throughout the area of the interconnect. The contact points can be formed as protrusions on both sides of the interconnect.

The efficiency of the fuel cell stack is also dependant of good contact in each of these contact points and therefore it is crucial that a suitable compression force is applied to the fuel cell stack. This compression force must be large enough and evenly distributed throughout the electrochemically active area of the fuel cell to ensure electrical contact but not so large that it damages the electrolyte, the electrodes, the interconnect or impedes the gas flow over the fuel cell.

During operation, the SOFC stack can be subjected to high temperatures up to approximately 1000 degrees Celsius causing temperature gradients in the SOFC stack and thus different thermal expansion of the different components of the SOFC stack. The section of the SOFC stack that experiences the largest expansion depends on the operating conditions and can for instance be located in the centre of the stack or at the border of the stack in for instance a corner. The resulting thermal expansion may lead to a reduction in the electrical contact between the different layers in the SOFC stack. The thermal expansion may also lead to cracks and leakage in the gas seals between the different layers leading to poorer functioning of the SOFC stack and a reduced power output.

To solve this problem of compression of a fuel cell stack, it is well known to use mechanical springs. In U.S. Pat. No. 7,001,685 a spring is used to provide compression on the whole surface of the stack and to absorb the differences in height of two stacks placed in electrical series. Mechanical springs, however, has the disadvantage that the compression force changes over time as the spring material creeps, especially when subjected to raised temperatures, and the compression force also changes as a function of the compression distance.

To solve the problems related to mechanical springs, it has been proposed to use gas pressure to compress the stack. This is described in US 20080090140, where a dynamic end-plate is pressed towards the end of a stack by a gas pressure. Solutions utilising gas pressure are also described in U.S. Pat. No. 5,419,980, US 20080166598, US 20050136316 and WO 2008026715.

However, whether mechanical springs or gas pressure is used for providing a compression force to the end plate of the stack there is a further disadvantage of not allowing the different sections of the fuel cell stack to expand individually and relatively independent to other sections as dictated by the operating conditions. Some of the mentioned references seek to solve this problem by incorporating gas pressure chambers between each of the cells a rather complex solution.

A more simple solution is described in EP 1879251, where the seal area and the active area of the cell stack is provided with independent compression forces which are applied only to the ends of the stack. Further the problem of creep of mechanically springs is sought to be solved as shown in FIG. 3 by the use of compressed air to compress the active area of the cells, whereby different zones of the cell can expand differently but still be compressed by an even compression force. Still, whether a range of mechanical springs as shown in FIG. 4 or 5 or a compressed air source is used, the solution leaves room for improvement on simplicity, efficiency, cost and reliability.

Therefore, in spite of the presented known solutions to the compression problem of a fuel cell stack, all of them have some of the inherent problems:
The more components involved in the compression system, the more expensive it is to produce and the higher the material costs. Further the risk of mal-function generally increases with increasing number of components.
The reliance of mechanical springs to compress the stack increases costs and especially when subjected to heat, mechanical springs tend to creep and therefore over time changes the spring characteristic.
Using an external compressed air source to compress the stack requires such an external air source and piping connections which increases the complexity of the system and increases costs and operation losses.

It is an object of the present invention to solve the mentioned problems by providing a new compression arrangement for a fuel cell stack.

More specifically it is an object of the invention to provide a compression casing assembly which omits the necessity for mechanical springs and extra external gas pressure sources to compress a fuel cell stack.

It is further an object of the invention to provide a compression arrangement which allows for differentiated compression force between the seal area and the electrochemically active area of a fuel cell stack.

It is yet a further object of the invention to provide a compression arrangement which allows for uneven expansion of different zones of the fuel cells yet maintains an evenly distributed compression force over the entire electrochemically area of the fuel cell stack in a simple and cost effective manner.

A further object of the invention is to provide a compression arrangement which automatically adjusts to the immediate operating conditions such as reactant gas flows,—pressures, temperatures and electrical load.

A further object of the invention is to provide a compression arrangement which requires few assembly processes during stack assembly and few stack components.

A further object of the invention is to provide a compression arrangement which entail no deterioration of the compression media over time.

These and other objects are achieved by the invention as described below.

Accordingly, a compression arrangement is provided for especially solid oxide fuel cells, but also potentially to other known fuel cell types as already mentioned. In the following the fuel cell stack will predominantly be regarded as a black box which generates electricity and heat when supplied with oxidation gas and fuel gas. The function and internal components of the fuel cell stack is considered known art and is not the subject of this invention.

The compression arrangement according to the present invention relates primarily to the electrochemically active area of the fuel cells in a stack. The seal area of the fuel cells requires a larger pressure than the active area and is therefore in the present invention assumed compressed by any suitable state of the art such as mechanical springs or a flexible compression mat. The seal area of the fuel cells is mainly located along the edges of the fuel cells and around internal manifolding chimneys. In case the fuel cells have one or more side manifolds for gas in- and outlets, these edges are not sealed, but can be applied with sealing points or contact points.

To divide the compression of the seal area from the compression of the electrochemically active area, the fuel cell stack is applied with a frame with an aperture, where the frame substantially covers the seal area and the aperture substantially covers the active area. It is understood that “substantially” means that the frame does not need to be of the exact same measures as the seal area and further that the frame which is exerting the relatively high compression force can be chosen to cover some parts of the electrochemically active area for practical reasons.

The frame rests on a planar end plate which is placed on top of the assembled stack of fuel cells. The end plate, in some embodiments a steel plate, is resilient, thus it allows for deformations of different sections of its cross sectional area. On top of the frame is a top plate and a seal is provided between the end plate and the frame, as well as between the frame and the top plate, whereby a gas tight compression chamber is formed which has substantially the same cross sectional area as the electrochemically active area of the fuel cells in the stack.

One or more gas pressure channels is provided to the compression chamber. The pressure channel(s) connect the compression chamber to one of the gas inlet channels or manifolds, the gas inlet can be either the cathode gas inlet or the anode gas inlet. In case the fuel cell stack is internally manifolded, the pressure channel(s) can be connected to one or more of the inlet manifold chimneys. In case the fuel cell stack is side manifolded, the pressure channel(s) can be connected to the inlet gas manifold; or in any case, the pressure channel can be connected to the preferred inlet gas by a separate pipe from the inlet of the frame and connected to any location of the inlet gas pipe.

In operation, inlet gas will be led to the compression chamber as well as to the fuel cell stack. As there is only inlet(s), but no outlet from the compression chamber, it will be subjected to any pressure of the inlet gas. In the fuel cells, the inlet gas, whether it is cathode gas or anode gas is distributed across the electrochemically active area and exits via outlets. Passage of the electrochemically active area causes a pressure drop between the inlet and the outlet. Therefore, as the inlet(s) of the compression chamber is connected to the gas inlet side of the stack via the pressure channel, the pressure drop across the active area results in an overpressure in the compression chamber, relative to the pressure in the gas outlet channel, of same magnitude as the pressure drop across the active area. Depending on the field of application, the stack itself can be subjected to either low or high internal gas pressures, as well as to either low or high external surrounding pressure.

A large internal pressure in the stack generated by the pressure loss of gas streaming across the active area will tend to press the stacked cells away from each other which will lead to reduced electrical contact and maybe even de-lamination. Also thermally induced mechanical stresses within the stack due to different thermal expansion entail these problems. But according to the invention, a rising internal pressure or thermally induced mechanical stresses in the fuel cell stack will be counterbalanced by a rising compression force generated by the rising pressure in the compression chamber.

Accordingly, it can be advantageous to connect the compression chamber to the inlet gas, which has the largest pressure, cathode or anode, but the invention is suited for the both as other considerations can determine whether it is preferred to connect the compression chamber to the cathode or the anode inlet gas.

In the embodiment described above, the bottom of the stack rests on a bottom plate as is known from the art. In another embodiment the compression arrangement can be applied to the bottom of the fuel cell stack, similar to the before mentioned embodiment, the frame can be applied between a resilient plate and the bottom plate.

In a further embodiment the described compression arrangement can be applied to both the top and the bottom of a fuel cell stack, in which case the allowance of independent local zone expansion of the fuel cell stack is further increased, but an evenly distributed compression force throughout the electrochemically active area of the cells is maintained.

In yet a further embodiment of the invention, the compression arrangement can be applied within the fuel cell stack at any location with one or more fuel cells located on each side of the compression arrangement. In this embodiment the frame is not in gas tight connection to one resilient plate and either a top or a bottom plate; instead it is in gas tight connection to two resilient intermediate plates, hereafter simply called resilient plates. Accordingly, in this embodiment, the compression chamber is formed by the aperture of the frame closed on both sides by resilient plates. The compression arrangement can be located in the middle of the stack, having a substantially even number of cells on either side or it can be located on any suitable location having a larger number of cells on one side than on the other. Further this embodiment can include more than one compression arrangement within a stack and it can be combined with the already mentioned embodiments i.e. a stack can have one or more compression arrangements according to this invention within the stack in combination with compression arrangements on the top, the bottom or both the top and the bottom of the stack.

### Features of the Invention

1. Compression arrangement for a fuel cell stack or an electrolysis cell stack made of a plurality of cells, the cell stack comprising
a plurality of stacked cells, each with a seal area and an electrochemically active area
a bottom plate
a top plate
at least one resilient plate
at least one frame with a central aperture
at least one gas inlet channel in fluid communication to a gas inlet side of the cells
at least one gas outlet channel in fluid communication to a gas outlet side of the cells
   said at least one frame is arranged in gas tight connection in-between at least one of:
the top plate and said resilient plate,
the bottom plate and said resilient plate,
two of said resilient plates located within the stack such that at least one compression chamber is formed by the aperture of the frame closed on both sides by said plates, said compression chamber is in fluid connection to the inlet gas by a pressure channel connected from the gas inlet channel to said compression chamber,
   wherein the cross-sectional area of said compression chamber substantially corresponds the electrochemically active area of said cells.

2. Compression arrangement for a cell stack according to feature 1, wherein the cell stack is a solid oxide fuel cell stack or a solid oxide electrolysis cell stack.

3. Compression arrangement for a cell stack according to feature 1 or 2, wherein the inlet gas is the cathode gas.

4. Compression arrangement for a cell stack according to feature 1 or 2, wherein the inlet gas is the anode gas.

5. Compression arrangement for a cell stack according to any of the preceding features, wherein the compression arrangement is located in the middle of the stack, having a substantially equal number of cells arranged on each side of the compression arrangement.

6. Compression arrangement for a cell stack according to any of the features 1-4, wherein the compression arrangement is located within the stack having a different number of cells arranged on one side of the compression arrangement than on the other side of the compression arrangement.

7. Compression arrangement for a cell stack according to any of the features 1-4, wherein a first compression arrangement is located at the top of the stack, a first compression chamber is formed by the aperture of a first frame closed on both sides by the top plate and a first resilient plate, and a second compression arrangement is located at the bottom of the stack, a second compression chamber is formed by the aperture of a second frame closed on both sides by the bottom plate and a second resilient plate.

8. Compression arrangement for a cell stack according to any of the features 1-4, wherein a first compression arrangement is located at the top of the stack, a first compression chamber is formed by the aperture of a first frame closed on both sides by the top plate and a first resilient plate, and a second compression arrangement is located at the bottom of the stack, a second compression chamber is formed by the aperture of a second frame closed on both sides by the bottom plate and a second resilient plate, and one or more further compression arrangements are located within the stack having compression chambers formed by the aperture of the one or more further frames closed on both sides by further resilient plates.

9. Compression arrangement for a cell stack according to any of the preceding features, wherein the overpressure in the compression chamber, relative to the pressure in the gas outlet channel, is between 20-1000 mbar, preferably between 40-500 mbar, preferably between 60-300 mbar.

10. A solid oxide fuel cell stack or a solid oxide electrolysis cell stack comprising a compression arrangement according to any of the preceding features.

The invention is further illustrated by the accompanying drawing showing an example of an embodiment of the invention.

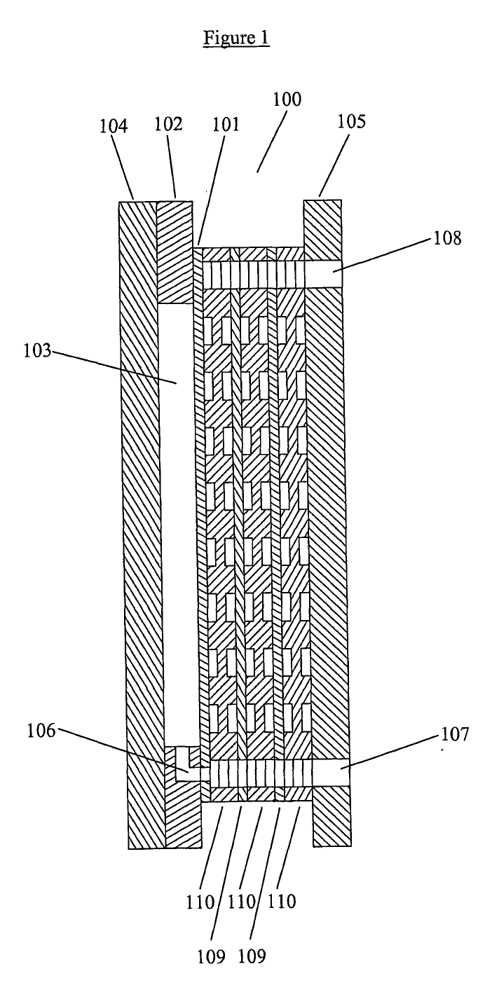

FIG. 1 shows a cut end view of the compression arrangement of a Solid Oxide Fuel Cell according to one embodiment of the invention.

Position Number Overview:
100 Solid Oxide Fuel Cell Stack.
101 Resilient plate (top).
102 Frame with central aperture (top).
103 Compression chamber.
104 Top plate.
105 Bottom plate.
106 Pressure channel.
107 Cathode gas internal inlet chimney.
108 Cathode gas internal outlet chimey.
109 Solid Oxide Fuel Cell.
110 Interconnect.

One embodiment of the invention is shown in FIG. 1. The embodiment shows the compression arrangement of the invention in connection to a solid oxide fuel cell stack comprising a number of solid oxide fuel cells separated by interconnects and stacked. Seals are provided between the stack components, but not shown.

The invention is not restricted to this embodiment neither concerning the compression arrangement or the type of fuel cells and their configuration. As already mentioned, the compression arrangement according to the invention can be applied to the top, the bottom, both the top and bottom of the fuel cell stack, and within the fuel cell stack in combination; and the fuel cell stack can comprise different types of fuel cells, which again can have different combinations of internal or external gas manifolds.

Referring to FIG. 1, a solid oxide fuel cell stack (100) comprises a number of solid oxide fuel cells (109). The fuel cell comprises electrolyte, cathode and anode. In this context, the details of the fuel cell is not crucial, thus it will be regarded as a unit with a seal area, and an electrochemically active area. The fuel cells are stacked on top of each other, with interconnects (110) in-between. An oxidising cathode gas stream, such as air, need to pass over the cathode side of the fuel cell and an anode gas stream, a fuel gas of suitable kind, need to pass over the anode side of the fuel cell. The interconnect separates the two gas streams and provides electrical contact between the cells.

The fuel cell stack is compressed between a rigid bottom plate (105) and a top plate (104). A resilient plate (101) and a frame (102) is placed on top of the fuel cell stack in-between the fuel cell stack and the top plate. The frame has a central aperture with a cross sectional area substantially corresponding to the electrochemically active area of the fuel cells, correspondingly this means that the part of the frame covering the fuel cell stack corresponds substantially to the seal area of the fuel cells.

The bottom plate, the fuel cells, the interconnects, the resilient plate, the frame and the top plate are all sealed together by glass sealing or other suitable material. Hence a gas tight cavity is formed between the resilient plate, the frame inside the aperture and the top plate. In some applications an acceptable gas tightness can even be achieved without sealing material. From the foregoing description it is understood that the cross sectional area of this gas tight cavity corresponds substantially to the electrochemically active area of the fuel cells. When the pressure inside this gas tight cavity is above the surrounding pressure, the resilient plate will press against the top of the fuel cell on the electrochemically active area, whereas the frame will press against the seal area by means of known in the art compression means (not shown). In this way the gas tight cavity forms a compression chamber (103).

The overpressure needed in the compression chamber to provide a sufficient compression force to the chemically active area of the fuel cells can be provided by an external pressure source. However, experiments have surprisingly shown that the pressure provided by the inlet cathode gas produces sufficient compression force to maintain contact between the fuel cell layers of the fuel cell stack. Therefore, instead of extra external equipment to provide the stack with compression gas only a connection to the cathode inlet gas is necessary. In the embodiment shown in FIG. 1 at least one pressure channel (106) provides fluid connection between the compression chamber and the cathode gas inlet channel. As the compression chamber has no outlets, the overpressure in the compression chamber, relative to the pressure in the cathode gas outlet channel, will be equal to the pressure loss over the cathode side of the fuel cell from the cathode gas inlet (107) to the cathode gas outlet (108).

### EXAMPLE

Experiments with the invention have been performed on several solide oxide fuel cell stacks. The stack was designed as described above, with cathode gas entering the frame from a hole in the end plate (the hole was placed towards the cathode gas inlet side). The stack comprised 10 fuel cells. A manometer was connected to an opening in the frame allowing measurements of the pressure in the frame. The test was performed under the following operating conditions:
Cathode flow: 960 Nl/h air
Stack temperature: 760° C.

The cathode flow of 960 Nl/h air resulted in an overpressure in the frame, relative to the pressure in the cathode gas outlet channel, of between 83 and 89 mbar, corresponding to a force between 76,5 N and 82 N exerted on the electrochemically active area.

No contact problems were observed during the test.

As already mentioned, the compression arrangement can also be provided on the bottom of the fuel cell stack or both at the top and the bottom or within the stack. Further, instead of cathode gas, anode gas can be used as compression media. The compression chamber inlet can be designed in different ways provided that a sufficient pressure is maintained in the compression chamber.

1. Compression arrangement for a fuel cell stack or an electrolysis cell stack made of a plurality of cells, the cell stack comprising
a plurality of stacked cells, each with a seal area and an electrochemically active area
a bottom plate
a top plate
at least one resilient plate
at least one frame with a central aperture
at least one gas inlet channel in fluid communication to a gas inlet side of the cells
at least one gas outlet channel in fluid communication to a gas outlet side of the cells
said at least one frame is arranged in gas tight connection in-between at least one of:
the top plate and said resilient plate,
the bottom plate and said resilient plate,
two of said resilient plates located within the stack such that at least one compression chamber is formed by the aperture of the frame closed on both sides by said plates, said compression chamber is in fluid connection to the inlet gas by a pressure channel connected from the gas inlet channel to said compression chamber,
wherein the cross-sectional area of said compression chamber substantially corresponds the electrochemically active area of said cells.

2. Compression arrangement for a cell stack according to claim 1, wherein the cell stack is a solid oxide fuel cell stack or a solid oxide electrolysis cell stack.

3. Compression arrangement for a cell stack according to claim 1, wherein the inlet gas is the cathode gas.

4. Compression arrangement for a cell stack according to claim 1, wherein the inlet gas is the anode gas.

5. Compression arrangement for a cell stack according to claim 1, wherein the compression arrangement is located in the middle of the stack, having a substantially equal number of cells arranged on each side of the compression arrangement.

6. Compression arrangement for a cell stack according to claim 1, wherein the compression arrangement is located within the stack having a different number of cells arranged on one side of the compression arrangement than on the other side of the compression arrangement.

7. Compression arrangement for a cell stack according to claim 1, wherein a first compression arrangement is located at the top of the stack, a first compression chamber is formed by the aperture of a first frame closed on both sides by the top plate and a first resilient plate, and a second compression arrangement is located at the bottom of the stack, a second compression chamber is formed by the aperture of a second frame closed on both sides by the bottom plate and a second resilient plate.

8. Compression arrangement for a cell stack according to claim 1, wherein a first compression arrangement is located at the top of the stack, a first compression chamber is formed by the aperture of a first frame closed on both sides by the top plate and a first resilient plate, and a second compression arrangement is located at the bottom of the stack, a second compression chamber is formed by the aperture of a second frame closed on both sides by the bottom plate and a second resilient plate, and one or more further compression arrangements are located within the stack having compression chambers formed by the aperture of the one or more further frames closed on both sides by further resilient plates.

9. Compression arrangement for a cell stack according to claim 1, wherein the overpressure in the compression chamber, relative to the pressure in the gas outlet channel, is between 20-1000 mbar, preferably between 40-500 mbar, preferably between 60-300 mbar.

10. A solid oxide fuel cell stack or a solid oxide electrolysis cell stack comprising a compression arrangement according to claim 1.
